(19) United States
(12) Patent Application Publication
(10) Pub. No.: US 2013/0264112 A1
(43) Pub. Date: Oct. 10, 2013

(54) CABLE FOR USE IN CONCENTRATED SOLAR POWER INSTALLATION

(71) Applicant: NEXANS, Paris (FR)

(72) Inventors: Hailong XU, Shanghai (CN); Mi LI, Shanghai (CN); XIONGWEN LIN, Wuhan City (CN)

(21) Appl. No.: 13/666,048

(22) Filed: Nov. 1, 2012

(30) Foreign Application Priority Data
Nov. 9, 2011 (CN) 201120441739.8

(51) Int. Cl. H01B 7/17

(52) U.S. Cl. CPC H01B 7/17
USPC 174/70 R; 174/102 R

(57) ABSTRACT

A cable (1) in particular for use in a concentrated solar power installation is provided, is provided with a core (2) for transmitting signals and/or power, an inner jacket (3) enclosing the core, an outer jacket (4) enclosing the inner jacket, and a shield (5) disposed between the inner and outer jackets. The shield is configured as a flexible conduit. A concentrated solar power installation comprising the cable is also provided.

### RELATED APPLICATION

This application claims the benefit of priority from Chinese Patent Application No. CN 2011 20441739.8, filed on Nov. 9, 2011, the entirety of which is incorporated by reference.

### BACKGROUND

1. Field of the Invention

The present utility model relates to a cable, and particularly to a cable for transmitting signals and/or power in a concentrated solar power (CSP) installation.

2. Description of the Related Art

A CSP installation concentrates sunlight by means of a plurality of light concentrated reflectors (e.g. mirrors), and heats up gaseous or liquid medium (such as oil or water) by the concentrated sunlight; then thermal energy of the medium is converted into mechanical energy which is finally converted into electric power.

For a CSP installation, in order to regulate the reflection angle of the light concentrated reflectors, it is necessary to supply the reflectors with signals and power such that the reflectors can move and thereby be adjusted in orientation as desired. To this end, cables for transmitting signals and power are installed between a communication/power distribute unit (CPDU) of the CSP installation and respective light concentrated reflectors.

Such a cable generally includes a core for transmitting signals and/or power, inner and outer jackets enclosing the core, and a shield disposed between the inner and outer jackets. The traditional design of the shield is in the form of a net structure weaved by steel wires or steel strips around the inner jacket, or a coating structure formed by winding a steel tape around the inner jacket. A cable haying a shield of these structures is defective mainly in that, the minimum bending radius of the cable is large, usually more than 100 mm, which adversely affects the flexibility and workability in cable installation. In addition, the cable is often installed above ground or directly buried in earth surface region in unfavorable environment (e.g. in desert), however, gaps in the form of meshes or clearances between windings present in the net structure or winding structure of the traditional shield result in insufficient strength and poor protection performance of the shield, thereby it is unable to provide thorough and reliable protection to the cable.

### OBJECTS AND SUMMARY

In view of the above, the object of the present utility model is to provide a cable which not only has good bending performance (i.e. with small minimum bending radius), but also is capable of being shielded against unfavorable environment and thus operates reliably. Such a cable is particularly applicable for transmitting signals and/or power in a CSP installation.

The above object can be achieved by the cable according to the present utility model, the cable comprising a core for transmitting signals and/or power, an inner jacket enclosing the core, an outer jacket enclosing the inner jacket, and a shield disposed between the inner and outer jackets, characterized in that the shield is configured as a flexible conduit.

According to a preferable configuration, the flexible conduit may be formed by connecting a plurality of tube sections in series, wherein every two adjacent tube sections are pivotable relative to each other.

Preferably, the wall of the tube sections may be S-shaped or C-shaped in the longitudinal section thereof, and every two adjacent tube sections are connected by hooking adjacent ends thereof onto each other.

Advantageously, the tube sections may have an outer diameter ranging from 20.5 to 24.5 mm, an inner diameter ranging from 17 to 21 mm, and a length ranging from 5.35 to 7.35 mm. In this case, the minimum bending radius of the cable may be less than 100 mm.

Advantageously, the flexible conduit may be made of galvanized steel tape, and the galvanized steel tape may have a thickness ranging from 0.2 to 0.8 mm, preferably 0.3 mm.

According to another preferable configuration, the flexible conduit may be configured as a corrugated pipe.

Due to the specially designed shield, the cable according to the present utility model can achieve small minimum bending radius (e.g. less than 100 mm), which may significantly improve the flexibility and workability in cable installation. In addition, the design of the shield enables the cable of the present utility model to reliably operate in unfavorable environment, for example, the cable can be good in anti-rodent performance, mechanical abuse (e.g. stepping on the cable) resistance, and UV and direct sunlight resistance.

The present utility model further provides a concentrated solar power installation comprising the cable as described above, wherein the cable is connected to light concentrated reflectors of the installation to transmit signals and/or power.

### BRIEF DESCRIPTION OF THE DRAWINGS

The accompanying drawings, which are incorporated in and constitute a part of this specification, illustrate exemplary embodiments of the present utility model and together with the description, serve to explain the principles of the present utility model, wherein:

FIG. 1 is a transverse section view of the cable according to an embodiment of the present utility model;

FIG. 2 is a longitudinal section view, in part, showing the shield of the cable according to an embodiment of the present utility model;

FIG. 3 is a perspective view of the cable according to an embodiment of the present utility model.

### DETAILED DESCRIPTION OF EMBODIMENTS

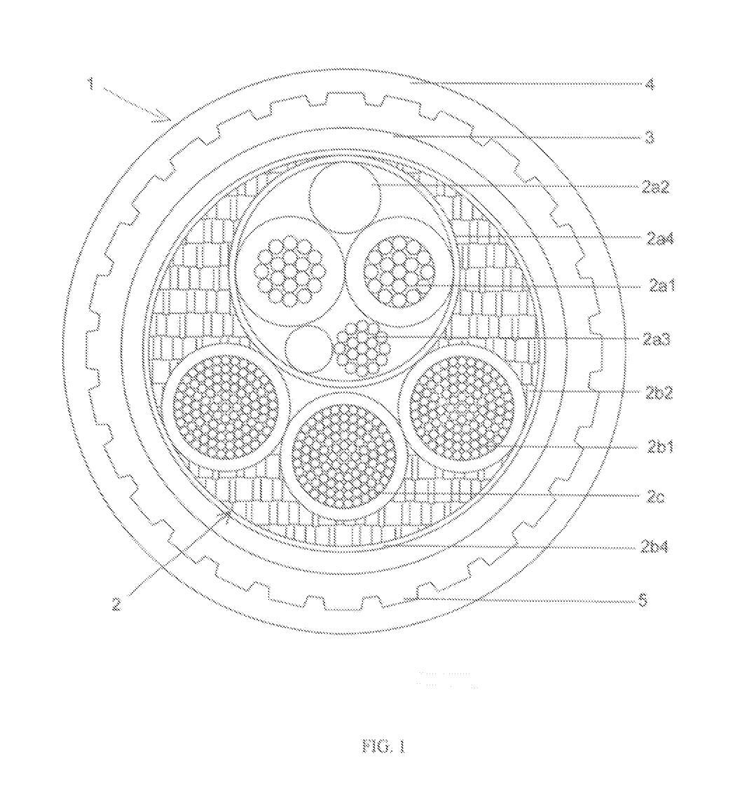

FIG. 1 shows the cross sectional structure of the cable 1 according to an embodiment of the present utility model. The cable 1 comprises a core 2 for transmitting signals and power, an inner jacket 3 enclosing the core 2, an outer jacket 4 enclosing the inner jacket 3, and a shield 5 disposed between the inner and outer jackets.

The core 2 may include a first component for transmitting signals and a second component for transmitting power. As shown in FIG. 1, the first component may include, for example, conductors 2a1 with insulation, fillers 2a2, drain wires 2a3 and a covering 2a4; the second component may include, for example, conductors 2b1 with insulation, optional fillers 2b2 and a covering 2b4, wherein the fillers 2b2 spread over the inner space of the covering 2b4; and the second component surrounds the first component. Optionally, the core 2 may further include drain wires 2c with insulation, which are arranged within the second component and relate to the power transmission function of the cable. The above conductors and drain wires in the core 2 may be formed by e.g. tinned copper wires, and the insulations and/or the fillers may be made of e.g. polyethylene (PE); the covering 2a4 of the first component may be e.g. an Al/PET tape, the Al facing inside, and the covering 2b4 of the second component may be e.g. a PET tape. The size, number and location in the core 2 of the above mentioned conductors, fillers, drain wires and coverings can be set according to application circumstances and specific requirements. In addition, the core 2 may be configured to transmit only signals or only power; in such a case, the cable includes merely one of the first component or the second component. The inner jacket 3 and/or outer jacket 4 may be formed of e.g. PVC material, in particular the outer jacket 4 may be formed of a UV-resistant PVC material.

The shield 5 is disposed between the inner jacket 3 and the outer jacket 4, and functions as structural support and protection of the cable 1. According to the present utility model, the shield 5 is designed as a flexible conduit. As compared with the net structure weaved by steel wires or the coating structure formed by winding a steel tape in the prior art, the flexible conduit demonstrates good bending performance and can achieve smaller minimum bending radius, thereby improving the flexibility and workability in cable installation. Furthermore, the flexible conduit has almost a completely closed structure, avoiding gaps or clearances present in the prior shield and thereby exhibiting better strength, such that even if the outer jacket is damaged, the conduit is invulnerable to biting by animals, and can effectively resist mechanical abuse (such as stepping) and thoroughly shield the core from UV and direct sunlight. The flexible conduit may be made of galvanized steel tape, for example, which not only ensures sufficient strength but effectively prevents damage to the conduit material caused by rapid oxidation, thereby prolonging lifetime of the conduit and improving operation reliability thereof. Nevertheless, the flexible conduit may also be made of any other suitable metal material.

According to an embodiment of the present utility model, the flexible conduit is formed by connecting a plurality of tube sections in series, wherein every two adjacent tube sections are pivotable relative to each other. Separating the conduit into a plurality of relatively pivotable tube sections facilitates the cable to achieve better flexibility and thereby obtain smaller minimum bending radius without causing fracture or breakage during bending.

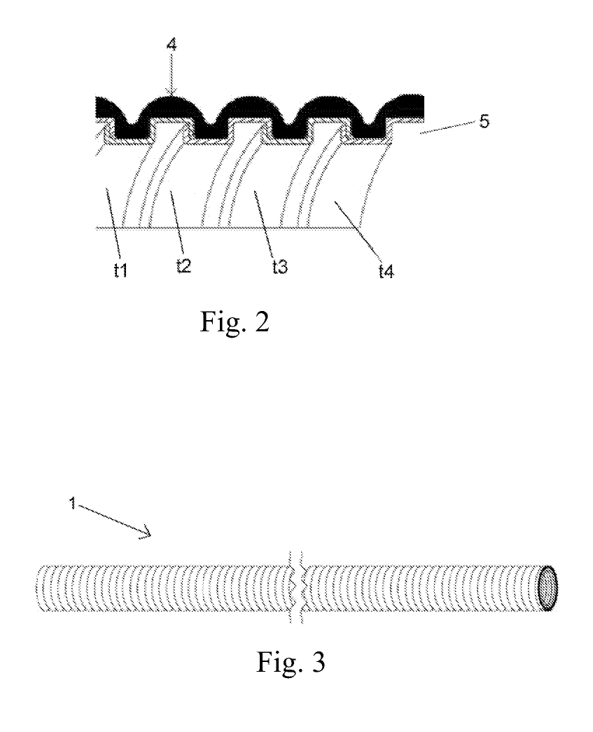

The partial longitudinal section view of FIG. 2 shows four tube sections t1, t2, t3 and t4 among the plurality of tube sections according to a preferable configuration. As shown in FIG. 2, the wall of the tube sections is S-shaped in the longitudinal section thereof and every two adjacent tube sections are connected by hooking the adjacent ends thereof onto each other. In other words, the respective two adjacent ends (hook shaped) of tube sections t1 and t2, tube sections t2 and t3, as well as tube sections t3 and t4 are hooked and caught on each other, such that a plurality of tube sections are connected together in such a way to form a flexible conduit. By means of relative sliding and pivotal movement at the connections of the tube sections, the flexible conduit of this preferable configuration has excellent flexibility and bending performance, in particular achieving smaller minimum bending radius. For this configuration, the S-shaped tube sections may have, for example, an outer diameter of 20.5 mm to 24.5 mm, preferably 22.5 mm, an inner diameter of 17 mm to 21 mm, preferably 19 mm, and a length of 5.35 mm to 7.35 mm, preferably 6.35 mm; and in this case, the minimum bending radius of the cable may be less than 100 mm. Nevertheless, the above sizes are not restrictive, and other minimum bending radii can be achieved by appropriately setting respective dimensions of each tube section according to application circumstances and/or specific requirements. In addition, the flexible conduit of this preferable configuration also has a substantially completely closed structure, which can obtain thorough and reliable protection effects as well. Furthermore, each of the above tube sections may be also made of galvanized steel tape. Advantageously, the thickness of the galvanized steel tape is in the range of 0.2-0.8 mm, for example, 0.3 mm. Naturally, other thicknesses can be selected according to different application circumstances and requirements. FIG. 2 also shows the outer jacket 4 enclosing the shield 5; herein the outer jacket 4 is closely engaged with the shield 5, whereby it is possible to suppress excessive translating movement of the tube sections relative to one another. FIG. 3 shows the exterior appearance of the cable according to the present utility model.

Although the wall of the tube sections is S-shaped in the longitudinal section as describe above, it may also be C-shaped. Then the flexible conduit is formed by connecting a plurality of C-shaped tube sections, wherein every two adjacent tube sections are arranged with their openings directed toward opposite directions, but are still connected by hooking adjacent ends thereof onto each other (the configuration equivalent to the case where the middle portion of each S-shaped tube section as shown in FIG. 2 is separated into two ends hooked onto each other).

It is to be noted that, although the plurality of tube sections are connected together by hooking onto one another as described above, the present utility model is not limited to this. Other appropriate connecting means and methods, such as hinge connection, may also be employed.

According to another embodiment of the present utility model, the flexible conduit may also be designed as a corrugated pipe. As compared with the prior structures of the shield, the corrugated pipe has better bending performance and a completely closed structure, enabling it to achieve smaller bending radius and provide thorough and reliable protection to the cable. The corrugated pipe may be made of metal, such as galvanized steel.

In view of the good bending performance, the capability of withstanding unfavorable environment and thus the high operation reliability as described above, the cable according to the present utility model is particularly suitable for transmitting signals and/or power in a CSP installation, which is installed above ground or directly buried in earth surface region in unfavorable environment. However, the cable according to the present utility model can also be employed in other applications in which signals and/or power is to be transmitted and meanwhile the cable is required to have small bending radius and be invulnerable to damages.

It will be apparent to those skilled in the art that various modifications and variations can be made to the above disclosed embodiments without departing from the scope or spirit of the present disclosure. Other embodiments of the present disclosure will be apparent to those skilled in the art from consideration of the specification and practice of the disclosure disclosed herein. It is intended that the specification and examples disclosed to be considered as exemplary only, with a true scope of the disclosure being indicated by the following claims and their equivalents.

1. A cable comprising:
a core for transmitting signals and/or power;
an inner jacket enclosing the core;
an outer jacket enclosing the inner jacket; and
a shield disposed between the inner and outer jackets, wherein the shield is configured as a flexible conduit.

2. The cable according to claim 1, wherein the flexible conduit is formed by connecting a plurality of tube sections in series, wherein every two adjacent tube sections are pivotable relative to each other.

3. The cable according to claim 2, wherein the wall of the tube sections is S-shaped or C-shaped in the longitudinal section thereof, and every two adjacent tube sections are connected by hooking adjacent ends thereof onto each other.

4. The cable according to claim 3, wherein the tube sections have an outer diameter ranging from 20.5 to 24.5 mm, an inner diameter ranging from 17 to 21 mm, and a length ranging from 5.35 to 7.35 mm.

5. The cable according to claim 4, wherein the minimum bending radius of the cable is less than 100 mm.

6. The cable according to claim 1, wherein the flexible conduit is made of galvanized steel tape.

7. The cable according to claim 6, wherein the galvanized steel tape has a thickness ranging from 0.2 to 0.8 mm.

8. The cable according to claim 1, wherein the flexible conduit is configured as a corrugated pipe.

9. A concentrated solar power installation comprising:
the cable according to claim 1, wherein the cable is connected to light concentrated reflectors of the installation to transmit signals and/or power.
